(19) United States
(12) Patent Application Publication
(10) Pub. No.: US 2025/0256635 A1
(43) Pub. Date: Aug. 14, 2025

(54) PORTABLE KITCHEN FRAMING SYSTEM FOR A VEHICLE

(71) Applicant: Kristopher Lee Kelso, Davenport, IA (US)

(72) Inventor: Kristopher Lee Kelso, Davenport, IA (US)

(21) Appl. No.: 18/437,699

(22) Filed: Feb. 9, 2024

(51) Int. Cl. B60P 3/34

(52) U.S. Cl. CPC B60P 3/34

(57) ABSTRACT

A portable kitchen framing system that disposes a row of kitchen accessories along an exterior of a pickup truck. The framing system includes a frame bracket that engages a gunwale of the pickup truck, whereby a plurality of orthogonally-oriented faces are provided by the frame bracket so that a user can removably connect a row of accessories to an outside of the truck, by way of an outward-facing face and, later, removably connect the same row of accessories within the storage area of the bed of the truck by way of an inward-facing face of the orthogonally oriented faces. A downward-facing face of the orthogonally oriented faces enables the clamping of the frame bracket to the gunwale. An upward-facing face of the orthogonally oriented faces may work in tandem for clamping as well as provide support for the inward and outward facing faces.

### BACKGROUND OF THE INVENTION

The present invention relates to vehicular camping and, more particularly, to a portable kitchen framing system for a vehicle.

Camping is an outdoor recreation enjoyed by millions of people around the world every year. Utilizing a non-recreational vehicle to get to the campground is sometimes referred to as “car camping”, or more accurately vehicular camping, and is one of America's favorite forms of camping. Typically, camping involves participants leaving developed areas to spend one or more nights away from home and its amenities, such as the appliances and features of a modern kitchen that facilitate preparing food.

True, vehicular campers can stow portable stoves for making food and conventional containers that hold water like a sink, but ‘roughing it’, involving handling and storing the bare necessities of food-preparation can diminish the enjoyment of and time spent in the outdoors. Additionally, storage of camping kitchen accessories takes up valuable space inside the vehicle.

As can be seen, there is a need for a portable kitchen framing system adapted to hold kitchen accessories outside a vehicle at a comfortable height for cooking and washing dishes, whereby the system of the present invention frees up space inside the vehicle.

### SUMMARY OF THE INVENTION

In one aspect of the present invention, assembly for supporting objects movable between an operative configuration along an exterior of a pickup truck and a storage configuration along an interior of a truck bed of the pickup truck, the assembly provides a frame bracket comprising four surfaces, wherein each surface is orientated approximately perpendicular relative to an adjacent surface of the four surface, wherein an upward-facing surface directly engage a gunwale of the truck bed, wherein a downward-facing surface is disposed directly below the gunwale, wherein an outward-facing surface projects beyond and above the gunwale, and wherein an inward-facing surface projects over a storage area of the truck bed.

In another aspect of the present invention, said assembly further includes wherein the outward-facing and inward-facing surface are parallel with each other, and wherein the upward-facing and downward-facing surface are parallel with each other; further including an accessory frame bracket connected to each of the outward-facing and inward-facing surfaces; further including a clamp operatively associated with the downward-facing surface and the gunwale; further including an accessory bracket removably connectable to either accessory frame bracket, wherein the accessory bracket provides a first portion and a second portion, where the first portion is configured to removably connect to the accessory frame bracket, and wherein the second portion is configured to support an accessory.

In yet another aspect of the present invention a system of supporting two rows of complementary accessories along an exterior of a pickup truck using the one or more of the above-mentioned assemblies, the system includes the following: one or more channels connected to a bed topper of the pickup truck, wherein the row of channels is disposed above the outward-facing surfaces of said one or more assemblies; and one or more first accessory brackets removably hung from the one or more channels, wherein the first accessory bracket supports one or more first accessories that has a height substantially greater than a height of one or more second accessories supported on the one or more accessory brackets operatively associated with said one or more assemblies, wherein the storage configuration, for each said assembly, a first accessory occupies a stacked relationship on the respective second accessory so that a combined height of the first and second accessories is less than a height of the first portion of the respective accessory bracket.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention shown in use.

FIG. 2 is an exploded perspective view of an exemplary embodiment of the present invention shown in use.

FIG. 3 is a section view of the exemplary embodiment of the present invention, taken along line 3-3 of FIG. 1.

FIG. 4 is a cross-sectional view, like FIG. 3, showing the exemplary embodiment of the present invention in a storage configuration 42.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a portable kitchen framing system that disposes two rows of kitchen accessories along an exterior of a pickup truck. The framing system contemplates a first row of accessories over a second row of accessories. The framing system for the second row of accessories has a frame bracket that engages a gunwale of the pickup truck, whereby a plurality of orthogonally-oriented faces are provided by the frame bracket so that a user can removably connect the second row of accessories to an outside of the truck, by way of an outward-facing face of the orthogonally-oriented faces, when food preparation is needed, and then when, not needed, removably connect the same the second row of accessories within the storage area of the bed of the truck by way of an inward-facing face of the orthogonally-oriented faces. A downward-facing face enables the clamping of the frame bracket to the gunwale. The first row of accessories may be dimensioned and sized to stack on the second row of accessories in the storage configuration.

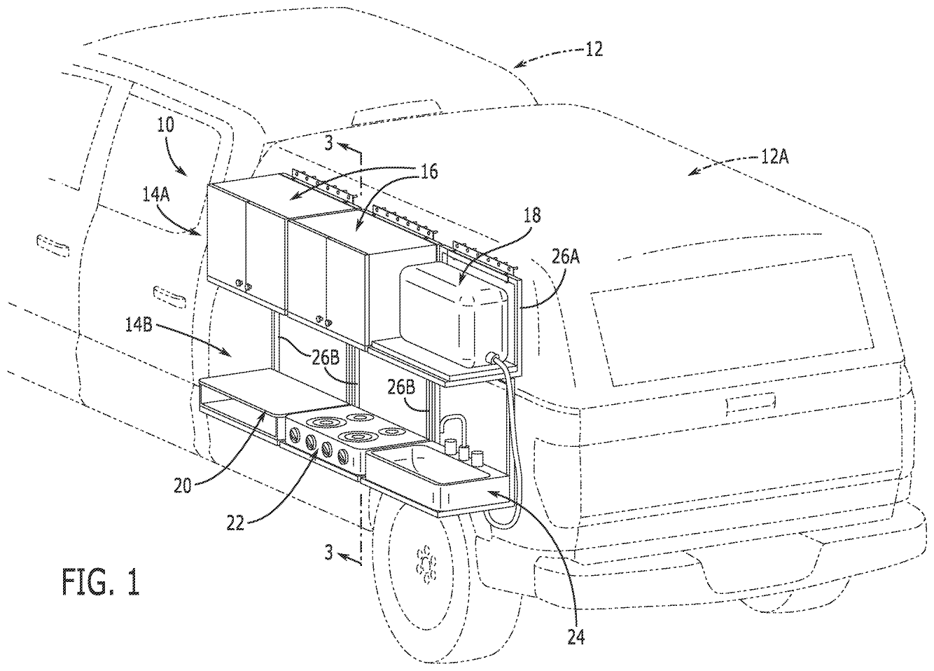

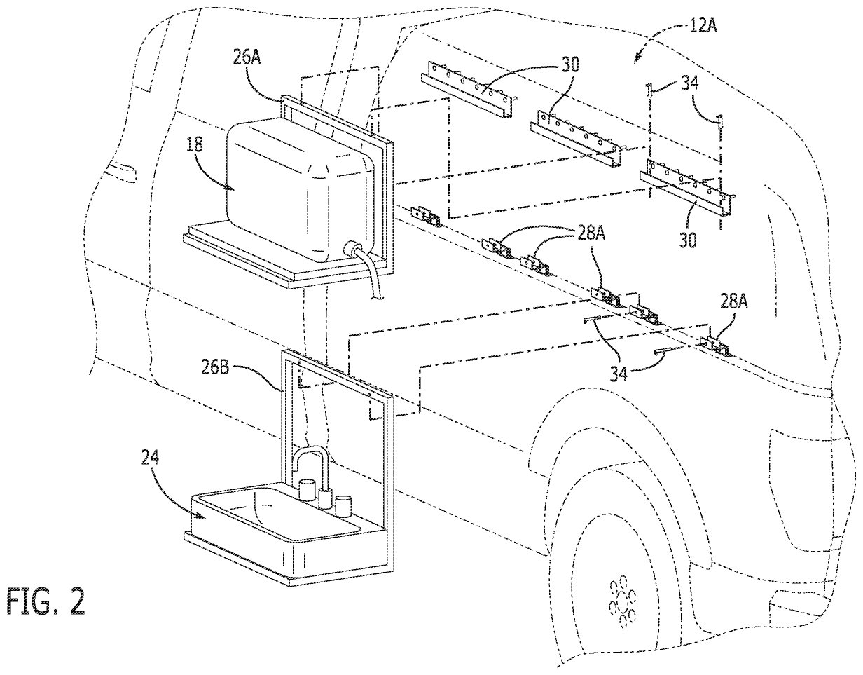

Referring to FIGS. 1 through 4, the present invention may include a portable kitchen framing system 10 for a vehicle 12 that is a pickup truck.

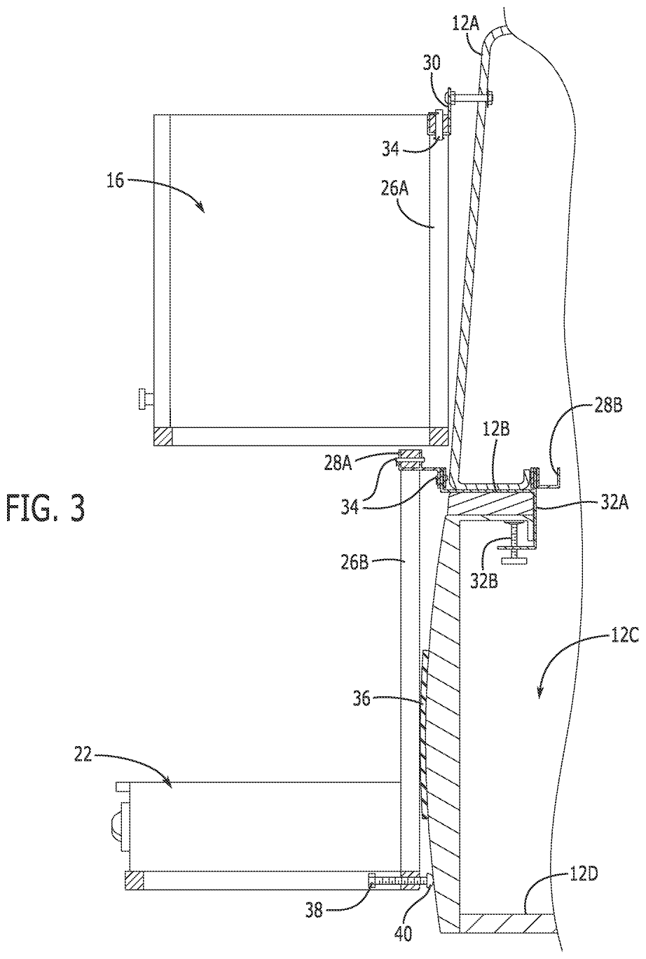

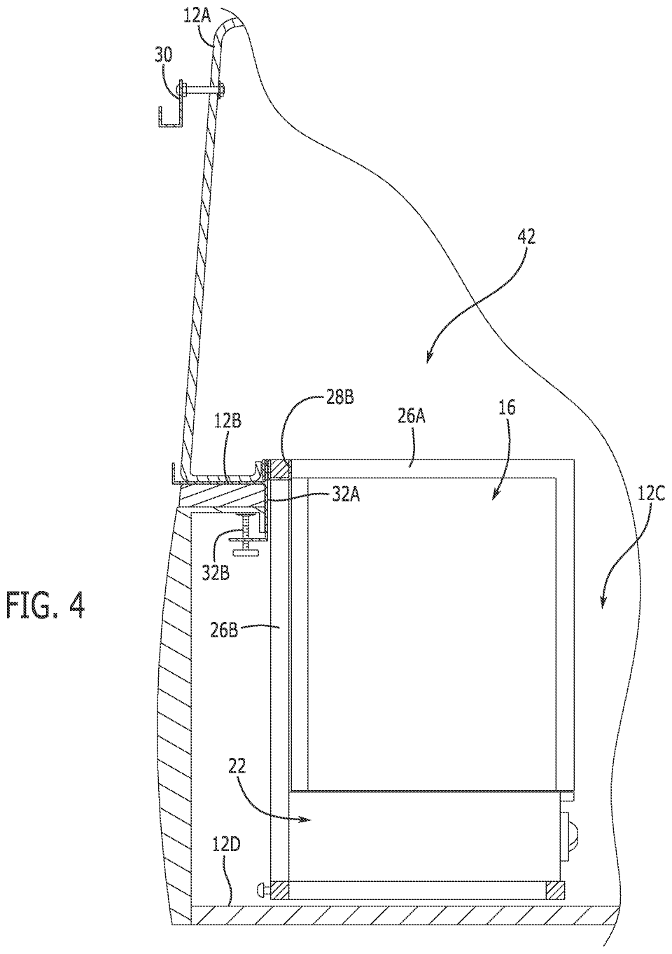

Along the gunwale 12B of the truck bed 12D the user may connect a truck bed bracket 32A by way of a clamp 32B. The truck bed bracket 32A provides at least four faces: an outward-facing (relative to the truck bed 12D) face, an inward-facing face, an upward-facing face, and a downward-facing face. The underside of the upward-facing face may be substantially flush with gunwale 12B. Approximately, the outward facing face may orthogonally project upward from a distal edge of the upward-facing face. The inward-facing face may be orthogonally joined to a proximal edge of the upward-facing face, so that the opposing edges of the inward-facing face projects above and below, respectively, the gunwale 12B. In some embodiments, the upper edge of the inward-facing face may substantially share an elevation of an upper edge of the outward-facing face. The downward-facing face is disposed directly below the gunwale 12B and within the storage area 12C of the truck bed 12D. In one embodiment, the clamp 32B operatively associates with both the downward-facing face and the underside of the gunwale 12B, as illustrated in FIGS. 3 and 4.

An inner accessory frame bracket 28B may project inward from the inward-facing face. An outer accessory frame bracket 28A may project outward from the outward-facing face. The accessory frame brackets 28A and 28B may provide upward-facing U-shaped channels (though other shaped and/or sized engagement surfaces are contemplated herein if they enable the functionality disclosed herein) to associate with fasteners 34, such as but not limited to locking pins, to removably attach portable kitchen accessories 16, 18, 20, 22, 24, etc. The portable kitchen accessories may include cabinet frame assembly 16, water supply frame assembly 18, a countertop and storage frame assembly 20, a stove frame assembly 22, and a sink frame assembly 24. Each accessory bracket 26B may include L-shaped frame bracket (again, other shaped and/or sized engagement surfaces are contemplated herein if they enable the functionality disclosed herein), with a vertical leg removably attached to the relevant frame bracket 28A/28B, while the horizontal leg of the frame assembly supports the relevant accessory, as shown in the illustrations.

Accordingly, the frame assemblies may be removably attached to the outward-facing face's outer accessory frame bracket 28A in an operative configuration, as illustrated in FIG. 3, and, when not needed, detached and removably attached to the inward-facing face's inner accessory frame bracket 28B in a storage configuration 42, as illustrated in FIG. 4. In storage configuration 42 the frame assemblies and their respective accessories occupy the truck bed storage area 12C.

In the operative configuration, a protective sheet 36 may be disposed between the body of vehicle 12 and a rearward side of the accessory bracket 26B. For similar reasons, a fastener 38 may engage a lower portion of the accessory bracket 26B to selectively dispose a protective buffer 40 (e.g., a rubber stopper) between that portion of the accessory bracket 26B and the outer body of the vehicle 12.

A user of the present invention may connect a plurality of J-channel brackets 30 (or other shaped and/or sized brackets if they enable the functionality disclosed herein) adjacent to an upper portion of a truck bed topper 12A, in series or rows, thereby allowing a user to hang accessory brackets 26A from these J-channel brackets 30 for removably supporting camping kitchen accessories.

The system embodied in the present invention contemplates at least two complementary arrangements of accessories 16, 18, 20, 22, and 24 divided into an upper framed out accessories 14A and lower framed out accessories 14B, as illustrated in FIG. 1. The lower framed out accessories 14B have a smaller vertical profile (i.e., a distance that defines a vertical height) than the upper framed out accessories 14A so that in the storage configuration 42, the accessories of the upper framed out accessories 14 may stack on complementary accessories of the lower framed out accessories 14B, as illustrated in FIG. 4.

The present invention is dimensioned and adapted to fit between the truck bed and shell with two clamps. A one-inch by one-inch square tube frame holder may support the frames and respective accessories, which fit on the frame brackets projecting inside or outside the truck bed storage area.

In one embodiment, two C-clamps that clamp to top of the truck bed with a plurality of frame elements that point up so a user can hang frame bracket on the outside and inside. The angled frame elements may be approximately three inches wide and approximately ⅛ of an inch thick. The frame bracket may have a 3/16″ gap for tight fit on the angled frame elements. The bracket may have an approximately one-inch×one-inch frame bracket to support objects off the side of the truck bed in a vertical position. The bracket and angled frame element may have a hole through it to lock it in place on the outside truck or utility trailer.

The 1×1 inch J-channel, approximately 18 inches in length may be used to support the frames off truck topper shell or utility trailers. Each frame bracket will have a hole for locking the frames up. Frames may have two rubber stoppers to hold the frame off the side of the truck.

The present invention may be used for more than camping; for instance, the present invention can be used for supporting a mobile kitchen for business or charitable purposes.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. An assembly for supporting objects movable between an operative configuration along an exterior of a pickup truck and a storage configuration along an interior of a truck bed of the pickup truck, the assembly comprising:
a frame bracket comprising four surfaces, wherein each surface is orientated approximately perpendicular relative to an adjacent surface of the four surface, wherein an upward-facing surface directly engage a gunwale of the truck bed, wherein a downward-facing surface is disposed directly below the gunwale, wherein an outward-facing surface projects beyond and above the gunwale, and wherein an inward-facing surface projects over a storage area of the truck bed.

2. The assembly of claim 1, wherein the outward-facing and inward-facing surface are parallel with each other, and wherein the upward-facing and downward-facing surface are parallel with each other.

3. The assembly of claim 2, further comprising an accessory frame bracket connected to each of the outward-facing and inward-facing surfaces.

4. The assembly of claim 3, further comprising a clamp operatively associated with the downward-facing surface and the gunwale.

5. The assembly of claim 4, further comprising an accessory bracket removably connectable to either accessory frame bracket.

6. The assembly of claim 5, wherein the accessory bracket provides a first portion and a second portion, where the first portion is configured to removably connect to the accessory frame bracket, and wherein the second portion is configured to support an accessory.

7. A system of supporting two rows of complementary accessories along an exterior of a pickup truck using the one or more assemblies of claim 6, the system comprising:
one or more channels connected to a bed topper of the pickup truck, wherein the row of channels is disposed above the outward-facing surfaces of said one or more assemblies; and
one or more first accessory brackets removably hung from the one or more channels, wherein the first accessory bracket supports one or more first accessories that has a height substantially greater than a height of one or more second accessories supported on the one or more accessory brackets operatively associated with said one or more assemblies,
wherein the storage configuration, for each said assembly, a first accessory occupies a stacked relationship on the respective second accessory so that a combined height of the first and second accessories is less than a height of the first portion of the respective accessory bracket.
